(19) United States
(12) Patent Application Publication
(10) Pub. No.: US 2005/0169221 A1
(43) Pub. Date: Aug. 4, 2005

(54) Decentralized bandwidth reservation mechanism for wireless networks

(75) Inventor: Richard Thomas Bennett, Vancouver, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/877,324

(22) Filed: Jun. 24, 2004

Related U.S. Application Data
(60) Provisional application No. 60/541,886, filed on Feb. 3, 2004.

(51) Int. Cl. G08C 17/00

(52) U.S. Cl. 370/338; 370/346

(57) ABSTRACT

In a wireless network incorporating a medium access control (MAC) protocol, a MAC reservation-sensing mechanism for facilitating network use by a plurality of stations, including listening to network traffic by a first station desiring to transmit on the network; determining the existence of reservation time slots on the network; identifying free time slots; broadcasting a reservation request for an identified free time slot to a second station on the network; coordinating, between the first station and the second station, to confirm that the identified free time slot is available; and iff there is no conflict on the network for the identified free time slot and the identified free time slot is confirmed to be free, transmitting data from the first station to the second station.

### RELATED APPLICATION

This application is related to U.S. Provisional U.S. Patent Application Ser. No. 60/541,886, filed Feb. 3, 2004, for Decentralized bandwidth reservation mechanism for wireless networks, and claims priority therefrom.

### FIELD OF THE INVENTION

This invention relates to wireless networks, and specifically to a protocol which allows stations on a wireless network to reserve time slots for transmission without the requirement of a centralized controller.

### BACKGROUND OF THE INVENTION

Current wireless network protocols, such as Wireless Fidelity (Wi-Fi: IEEE 802.11b) and Wi-Media, require a central reservation system, which is accessed by stations on the network in order to reserve time slots in which the station may broadcast over the network. The reservation system requires a central controller and request/acknowledgement protocols, which are time consuming, and which, given a wireless network with a plurality of stations, results in slow network access by the stations connected to the network.

U.S. Pat. No. 5,638,371, for Multiservices medium access control protocol for wireless ATM system, of Raychaudhuri et al., granted Jun. 10, 1997, describes a means of mapping ATM system frames and procedures to a wireless medium consisting of a base station and one or more remote stations, requires the base station to manage all time slot allocations, and relies on an ALOHA scheme to request allocations from the base station.

U.S. Pat. No. 5,684,791 for Data link control protocols for wireless ATM access channels, of Raychaudhuri, granted Nov. 4, 1997, describes a data link procedure for wireless ATM network channel access based on dynamic TDMA (time division multiple access)/TDD(time division duplexing) framework.

U.S. Patent Publication No. 2002/0071413 A1, for Wireless MAC protocol based on a hybrid combination of slot allocation, token passing, and polling for isochronous traffic, of Choi, published Jun. 13, 2002, describes a wireless medium access control (MAC) protocol which uses a combination of slot (bandwidth) allocation, a variation on conventional token passing and polling for use in regulating isochronous traffic transmission, which MAC relies on a central access point sending a Beacon seen by all nodes for allocation of TDMA slots.

U.S. Patent Publication No. 2002/0071448 A1, for Collision avoidance in IEEE 802.11 contention free period (CFP) with overlapping basic service sets (BSSs), of Cervello et al., published Jun. 13, 2002, describes a two-way handshake in the Contention-Free Period to allow overlapping 802.11 LANs to divide available bandwidth.

U.S. Patent Publication No. 2002/0163933 A1, for Tiered contention multiple access (TCMA): a method for priority-based shared channel access, of Benveniste, published Nov. 7, 2002, describes a system for centralized control of network access.

U.S. Patent Publication No. 2003/0012166 A1, for Hybrid coordination function (HCF) access through tiered contention and overlapped wireless cell mitigation, of Benveniste, published Jan. 16, 2003, describes a method by which a central controller can regulate access to the medium.

U.S. Patent Publication No. 2003/0035396 A1, for Method for mapping quality of service requirements to radio protocol parameters, of Haartsen et al., published Feb. 20, 2003, describes a method of translating QoS semantics from one syntax to another.

U.S. Patent Publication No. 2003/0156553 A1, for ‘Shield’: protecting high priority channel access attempts in overlapped wireless cells, of Benveniste, published Aug. 21, 2003, describes a method of coordinating network accesses in overlapping groups of nodes, each controlled by a master station.

U.S. Patent Publication No. 2003/0174664 A1, for Preemptive packet for maintaining contiguity in cyclic prioritized multiple access (CPMA) contention-free sessions, of Benveniste, published Sep. 18, 2003, describes a method wherein contention-free sessions are interleaved on a periodic basis across two cells, or collections of nodes operating under centralized control. The reference describes use of interframe space, and ping-pongs network access between two master stations.

U.S. Patent Publication No. 2003/0174665 A1, for Access method for periodic contention-free sessions, of Benveniste, published Sep. 18, 2003, describes a variation on the method in the U.S. Patent Publication No. 2003/0174664. The reference describes a cell-based system which does not permit free topologies, and uses the interframe space instead of an explicit protocol to make reservations.

JP 11045230, for Server decentralization system and server decentralizing method, of Kiko, Published Feb. 16, 1999, describes transmission and reception of data without lowering the data quality, even if the transmission bandwidth of a server or network bandwidth enters an overload state by decentralization and reservation of the transmission bandwidth of each server needed for data transmission in the router according to transmission bandwidth information on the server. The reference describes a method for balancing load in a wire-line network consisting of a single server and multiple clients.

JP06216942, for Function decentralization of packet switching network, of Derby et al., published Aug. 5, 1994, describes decentralize control functions among various nodes of the packet switching network, etc., by extending a 1-bit copy flag included in the network header of a packet into a multi-bit field of a copy ID field. The reference describes a method of decentralizing certain control functions in a wireline, asynchronous packet network.

Zhu et al., A Five-Phase Reservation Protocol (FPRP) for Mobile Ad Hoc Networks, Proceedings of IEEE Conference on Computer Communications (INFOCOM), volume 1, pages 322-331, San Francisco, Calif., USA, (Mar. 29-Apr. 2, 1998), describes a protocol which employs a contention-based mechanism in which nodes compete with each other to acquire time slots. A reservation is made through a localized conversation between nodes in a 2-hop neighborhood.

### SUMMARY OF THE INVENTION

In a wireless network incorporating a medium access control (MAC) protocol, a MAC reservation-sensing mechanism for facilitating network use by a plurality of stations, including listening to network traffic by a first station desiring to transmit on the network; determining the existence of reservation time slots on the network; identifying free time slots; broadcasting a reservation request for an identified free time slot to a second station on the network; coordinating, between the first station and the second station, to confirm that the identified free time slot is available; and iff there is no conflict on the network for the identified free time slot and the identified free time slot is confirmed to be free, transmitting data from the first station to the second station.

It is an object of the invention to provide a conflict-free wireless network protocol.

Another object of the invention is to provide for implementation of UWB networks in a home environment for consumer electronics devices providing much higher performance than is possible with competing approaches, such as Wi-Fi and IEEE 802.15.3(a).

Another object of the invention is to provide a MAC protocol which allows reservation time slots to be re-used throughout an extended network in areas where transmitters and receivers do not overlap.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

FIG. 2 depicts implementation of the method of the invention in a five-node wireless network.

### DETAILED DESCRIPTION OF THE PREFERRED EMBODIMENT

The protocol of the method of the invention allows stations in a wireless home network to make bandwidth reservations without the use of the centralized reservation station required by current practice. It also guarantees that reservations may be made without a flurry of responses from adjacent stations, as required by one alternative approach. It provides, at minimum, a doubling of performance for ultra-wide band (UWB) networks two-tiers deep over the traditional 802.15.3 MAC protocol for UWB, and a geometric advantage for networks more than two tiers deep.

This method of the invention allows UWB networks to be implemented in a home environment for consumer electronics devices, and provides much higher performance than is possible with competing approaches, such as Wi-Fi and IEEE 802.15.3(a).

The method of the invention provides a bandwidth reservation system for wireless networks, which allows reservation time slots to be re-used throughout an extended network in areas where transmitters and receivers don't overlap. The protocol of the invention makes reservations without intervention by a central station. The mechanism is implemented as a Medium Access Control (MAC) protocol.

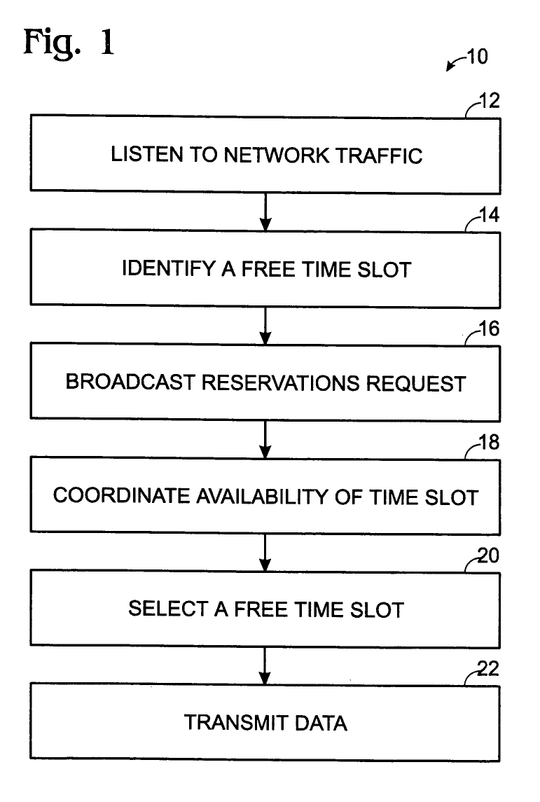

Referring to FIG. 1, a MAC reservation-sensing multiple access (MAC RSMA) protocol according to the method of the invention is depicted generally at 10. In this MAC RSMA protocol, a first station desiring to reserve bandwidth to transmit data on the network to one or more other stations first listens to the medium, 12, i.e., a radio channel, for sufficient time to sense existing reservations and the determine the existence of reservations and free time slots. It then proposes a reservation by broadcasting for the desired time slot that it has identified to be free 14, and advertises its requirements by broadcasting a reservation request 16. The partner, or second, station to the reservation duplicates the listening/proposing procedure 18, and advises of an alternate time slot in the event that it senses a conflict. When both partner stations are in agreement on a non-conflicting time slot, they seek conflict information from adjacent stations, e.g., iff (if and only if) there is no conflict on the network for the identified free time slot and the identified free time slot is confirmed to be free, transmitting data from the first station to the second station.

If a conflict is found, the two stations repeat the reservation advice procedure until a free time slot is found, or a retry limit is reached. If no conflict is found, the two stations seize the time slot 20 and advertise reservation information in each data transfer 22.

This invention makes unique use of certain characteristics of isochronous time slots on radio networks: (1) the regular and repetitive nature of data transmissions; (2) the irregular nature of radio coverage; (3) the limited distance of radio transmissions generally, and (4) their especially limited nature in UWB networks.

Multiple Frame Types

As previously noted, the protocol of the method of the invention includes a MAC Reservation-sensing Multiple Access (MAC RSMA) protocol, and uses a number of frame types, each for a specific purpose. This approach differs from classic Ethernet protocol, which has only one frame type, and conforms to UTP Ethernet, including flow control frames, data frames, and collision signaling frames, and wireless protocols which provide various management frames as well as data frames.

Reservation

Rather than relying on the centralized Beacon frames, used by Wi-Fi and TG3, the MAC of the method of the invention uses a decentralized bandwidth request, similar to that of the Wi-Fi RTS frame, but generalized over a stream, rather than relating simply to a single transfer. The RSMA reservation frame is a request for a recurring time slot: it's sent when the creator of a session, which may be either the source or the sink, but should be the clock master, determines there are no conflicting reservations in its coverage area. It makes this determination by listening for a long enough time period to see all the reservations that are visible from its vantage point. Data frames all carry reservation information.

Frame Format

Each data transfer frame in RSMA has the following format:

TABLE 1

| | | | | | | |
|---|---|---|---|---|---|---|
| Preamble | Reservation | Dest | Src Addr | T/L | Payload | CRC |
| | | Addr | (source | (type/ | | |
| | | | address) | length) | | |

It may be assumed that all fields but the Reservation Field are formatted in the conventional way, and it may also assumed that the Reservation Field is formatted in a manner similar to conventional beacon frames in the IEEE 802.11 and IEEE 802.15.3 MAC protocols. The semantics of the reservation field are as follows:
1. Time stamp—time the frame was released into the air according to the master clock.
2. Offset—reservation time slot start time relative to the master clock period.
3. Reservation period—amount of time reserved in each period.
4. Recurrence—the frequency with which the reservation recurs.
5. End time—the time that the reservation is cancelled, which may be set to “never”.
   This format is observed for all data and acknowledgement frames.
   Request for Reservation

The request for a time slot isn't complete until it's acknowledged by a reservation confirm frame, which follows a provisional acceptance and isn't vetoed by a neighbor. The flow is depicted in Table 2:

TABLE 2

| Clock Master | Neighbor | Clock Slave |
|---|---|---|
| Reservation Request --> | | |
| | <--Reservation Advice--> | |
| | | <-- Reservation Advice |
| | <--Reservation Advice--> | |
| | | <-- Reservation Advice |
| | <--Reservation Advice--> | |
| Reservation Select --> | | |
| | <--Veto--> | |
| | | <- Reservation Confirm/Deny |
| | <--Veto--> | |
| Reservation Affirm--> | | |

Reservation Request: Requests a recurring time slot with parameters for minimum bandwidth and desired bandwidth.
Reservation Advice: Reports existing reservations that have to be avoided for this new reservation to be allowed. All systems, i.e., those not directly involved in the new reservation as well as those that are, need to have randomized delay time before responding with their advice, and Reservation Advice reports need to be confirmed in order to avoid problems with colliding Reservation Advices. The target system (clock slave) listens for long enough to see any reservations visible from its vantage point that may conflict with the sought-after reservation, but neighbor systems simply report on their own conflicts, if any.
Reservation Select: Selects a time slot from those available, i.e., not already reserved and not reported by Reservation Advice.
Veto: Reports a conflict with the selected reservation time slot and an existing reservation. This is a double-check in case a Reservation Advice packet wasn't delivered successfully, or in case the holder of a reservation didn't see the Reservation Request.
Reservation Confirm/Deny: Acknowledges that a Selected Reservation is available and doesn't conflict with any other known reservation, providing hidden-node protection against the Reservation Select, or reports a conflict with a known reservation. If the reservation is denied, the Clock Master (CM) recalculates and sends a new Reservation Select frame. If the Reservation Confirm is lost, the CM sends a duplicate Reservation Select.
Reservation Affirm: Acknowledges that the Confirmed reservation has been activated and no further handshaking is required.

If the reservation can not successfully be negotiated, the CM can switch to another channel or hopping sequence, if any is available, or it can request a smaller allocation. If the reservation is successfully negotiated, the requesting system simply seizes the time slot and begins using it.

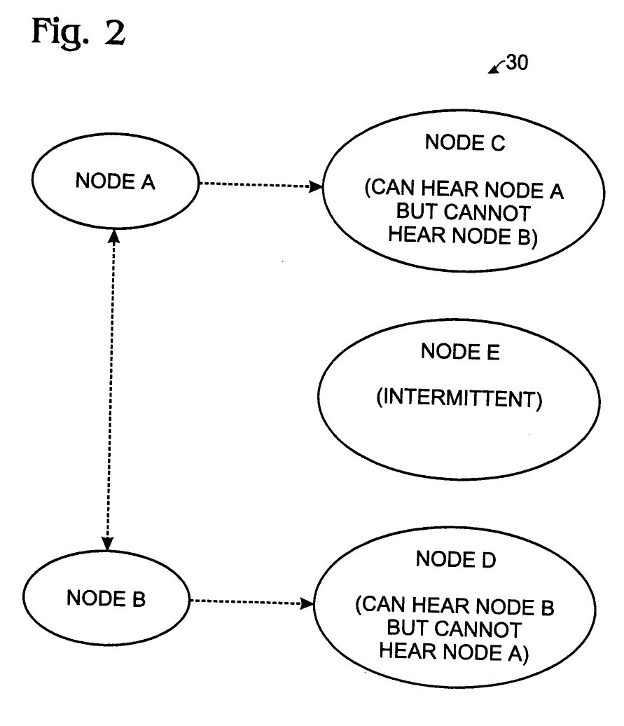

For purposes of illustration, and now referring to FIG. 2, it is sufficient to consider a network 30 of five nodes, where A and B desire to communicate, and C and D are in communication with nodes outside the reach of the receivers and transmitters of nodes A and B, and Node E is a mobile node in occasional contact with the others.

In the first phase of the reservation, Node A listens and discovers that Node C is using the first time slot, so it marks this slot busy in its local map and decides to use the second slot. It sends out a Reservation Request which is received by B and C. C notes no conflict between the slot it's using and remains silent, and B goes into a listening mode to determine whether it senses a conflict. Node B notices that Node D is transmitting in the time slot requested by A, but doesn't use the entire time, rather only one slot in five. Therefore Node B advises Node A to use the slots not used by D with the Reservation Advise packet. Node A selects the one slot in five, avoiding the slot used by D and sends out a Reservation Select packet. Mobile Node E receives this packet, and notices a conflict with a slot it's using, so it sends out a Veto packet informing Node B of his reservations. Node B then sends out a Reservation Deny packet, forwarding Node E's reservation information. Node A revises his request and sends another Reservation Select, to which there are no conflicts. Node B then sends out a Reservation Confirm packet. There being no vetoes of this packet, Node A sends a Reservation Affirm and proceeds to use the time slot it's reserved.

In the event that a hidden node is affected by the transmission, but that node can't be seen by A or B, there is no explicit mechanism for requesting a non-conflicting reservation, so all the nodes will have to monitor error rates and seek a different time slot if the error rate becomes too high, a symptom of collision with the hidden node. In this and other ways, network nodes using this mechanism may supplement it with additional knowledge of network conditions that's gained empirically.

Thus, a decentralized bandwidth reservation mechanism for wireless networks has been disclosed. It will be appreciated that further variations and modifications thereof may be made within the scope of the invention as defined in the appended claims.

1. In a wireless network incorporating a medium access control (MAC) protocol, a MAC reservation-sensing mechanism for facilitating network use by a plurality of stations, comprising:
listening to network traffic by a first station desiring to transmit on the network;
determining the existence of reservation time slots on the network;
identifying free time slots;
broadcasting a reservation request for an identified free time slot to a second station on the network;
coordinating, between the first station and the second station, to confirm that the identified free time slot is available; and
iff there is no conflict on the network for the identified free time slot and the identified free time slot is confirmed to be free, transmitting data from the first station to the second station.

2. The mechanism of claim 1 wherein said coordinating includes, if the identified free time slot is not free, identifying and selecting an alternate free time slot.

3. The mechainism of claim 2 wherein said identifying and selecting is performed by the second station.

4. The mechainism of claim 1 wherein said coordinating includes seeking conflicting information from other stations on the network and selecting and alternate free time slot if conflicts are detected with the identified free time slot.

5. The mechainism of claim 1 wherein said transmitting includes transmitting reservation information in each data transfer.

6. The mechainism of claim 1 wherein said coordinating includes, upon determination of no conflicts for the identified free time slot, seizure of the free time slot by the first station and the second station, and advertising reservation information in each data transfer.

7. The mechainism of claim 1 wherein the MAC RSMA includes a frame format having a preamble frame, a reservation frame, a destination address frame, destination address field, search address field, type/length field, payload field, and CRC field.

8. The mechainism of claim 7 wherein the reservation field includes a time stamp, providing the time which the frame was released into the air according to a master clock; an offset providing a reservation time slot start time relative to the master clock period; a reservation period indicating the amount of time reserved in each period; recurrence which provides the frequency with which the reservation recurs; and end time which provides the time that the reservation is cancelled.

9. The mechainism of claim 1 which includes a reservation request by the first station, multiple reservations advices by other stations on the network, a reservation select by the first station, a reservation conform/deny by other stations on the network, and a reservation affirm by the first station.

10. The mechainism of claim 1 which includes selecting another channel on the network if a free time slot cannot be located.

11. In a wireless network incorporating a medium access control (MAC) protocol, a method of MAC reservation-sensing mechanism for facilitating network use by a plurality of stations, comprising:
listening to network traffic by a first station desiring to transmit on the network;
determining the existence of reservation time slots on the network in a channel of the network;
identifying free time slots;
broadcasting a reservation request for an identified free time slot to a second station on the network;
coordinating, between the first station and the second station, to confirm that the identified free time slot is available, and if the identified free time slot is not free, identifying and selecting an alternate free time slot;
iff there is no conflict on the network for the identified free time slot and the identified free time slot is confirmed to be free, transmitting data from the first station to the second station; and
selecting another channel on the network if a free time slot cannot be located.

12. The method of claim 11 wherein said identifying and selecting is performed by the second station.

13. The method of claim 11 wherein said coordinating includes seeking conflicting information from other stations on the network and selecting and alternate free time slot if conflicts are detected with the identified free time slot.

14. The method of claim 11 wherein said transmitting includes transmitting reservation information in each data transfer.

15. The method of claim 11 wherein said coordinating includes, upon determination of no conflicts for the identified free time slot, seizure of the free time slot by the first station and the second station, and advertising reservation information in each data transfer.

16. The method of claim 11 wherein the MAC RSMA includes a frame format having a preamble frame, a reservation frame, a destination address frame, destination address field, search address field, type/length field, payload field, and CRC field.

17. The method of claim 16 wherein the reservation field includes a time stamp, providing the time which the frame was released into the air according to a master clock; an offset providing a reservation time slot start time relative to the master clock period; a reservation period indicating the amount of time reserved in each period; recurrence which provides the frequency with which the reservation recurs; and end time which provides the time that the reservation is cancelled.

18. The method of claim 11 which includes a reservation request by the first station, multiple reservations advices by other stations on the network, a reservation select by the first station, a reservation conform/deny by other stations on the network, and a reservation affirm by the first station.
